(19) United States
(12) Patent Application Publication
(10) Pub. No.: US 2026/0347245 A1
(43) Pub. Date: Nov. 5, 2026

(54) LOW EMISSIVITY GLASS PRODUCT AND MANUFACTURING METHOD THEREOF

(71) Applicant: Kreemo Inc., Seoul (KR)

(72) Inventors: In Seok JANG, Goyang-si (KR); In Kyung HONG, Seoul (KR); Hyun Soo KIM, Incheon (KR); Seong Tae JEONG, Yongin-si (KR); John Joonho PARK, Seongnam-si (KR)

(73) Assignee: Kreemo Inc., Seoul (KR)

(21) Appl. No.: 19/544,245

(22) Filed: Feb. 19, 2026

(30) Foreign Application Priority Data
Apr. 30, 2025 (KR) 10-2025-0057029

(51) Int. Cl. C03C 17/36; C03C 23/00

(52) U.S. Cl. CPC C03C 17/366; C03C 17/3644; C03C 17/3668; C03C 23/0025; C03C 2217/256; C03C 2218/328

(57) ABSTRACT

Disclosed herein are a glass product having low-emissivity characteristics and a method of manufacturing the same. The glass product may include a glass layer, and a thermal insulation coating layer bonded to the glass layer and including a pattern formed by removing a portion thereof. The thermal insulation coating layer may include at least one dielectric layer and at least one metal layer, and at least one dielectric layer of the thermal insulation coating layer may be preserved over an entire area thereof.

### CROSS-REFERENCE TO RELATED APPLICATION

This application claims the benefit of and priority to Korean Patent Application No. 10-2025-0057029, filed on Apr. 30, 2025, the entire disclosure(s) of which is hereby incorporated herein by reference in its entirety.

### TECHNICAL FIELD

The present disclosure relates to low-emissivity glass and, more particularly, to a glass product having low-emissivity characteristics while transmitting electromagnetic waves in a specific frequency band, and a method of manufacturing the same.

### BACKGROUND

Low-emissivity glass is a special type of glass on which a metal film that transmits visible light and reflects infrared light is coated. Thus, in a building in which the low-emissivity glass is installed, thermal insulation performance is improved and indoor temperature control is facilitated. However, since the metal film coated on the low-emissivity glass blocks not only infrared light but also radio waves, it is difficult for a wireless communication signal to reach the interior of the building in which the low-emissivity glass is installed.

In a wireless communication system, when a received signal strength between a base station and a terminal is reduced, a stronger signal is transmitted to compensate for the reduction. In this case, exposure to high levels of electromagnetic waves in the vicinity of the base station raises health and safety concerns, and increased power consumption in the terminal leads to an increased battery discharge rate.

To solve these problems, in the building in which the low-emissivity glass is installed, a method of installing a repeater inside the building to improve a shadow area is generally used. However, when the repeater is used, additional power is consumed during building operation, and operating costs increase due to maintenance and repair of the repeater. Therefore, there is a need for low-emissivity glass that reflects infrared light while transmitting radio waves in a frequency band used for wireless communication.

### SUMMARY

In view of the above, one object of the present disclosure is to provide a glass product capable of transmitting radio waves in a specific frequency band while maintaining low-emissivity characteristics.

Another object of the present disclosure is to provide a method of manufacturing a glass product capable of transmitting radio waves in a specific frequency band while maintaining low-emissivity characteristics.

However, objects to be solved by the present disclosure are not limited thereto, and may be expanded in various ways without departing from the spirit and scope of the present disclosure.

The present disclosure provides a glass product including a glass layer, and a thermal insulation coating layer bonded to the glass layer and including a pattern formed by removing a portion thereof, and the thermal insulation coating layer may include at least one dielectric layer and at least one metal layer, and at least one dielectric layer of the thermal insulation coating layer may be preserved over an entire area thereof.

The thermal insulation coating layer may include a dielectric layer in which the pattern is formed, and a dielectric layer having an entire area preserved.

The dielectric layer having the entire area preserved may maintain visibility of the glass product.

The at least one metal layer may include silver, and the dielectric layer having the entire area preserved may prevent corrosion of the silver.

The dielectric layer in which the pattern is formed may be provided between the dielectric layer having the entire area preserved and the glass layer, and the pattern may be formed by laser processing performed from the glass layer toward the at least one metal layer.

The dielectric layer having the entire area preserved may be provided between the dielectric layer in which the pattern is formed and the glass layer, and the pattern may be formed by laser processing performed from the at least one metal layer toward the glass layer.

A thickness of the at least one metal layer may be thinner than a thickness of the at least one dielectric layer.

The pattern may determine a frequency band of radio waves transmitted through the glass product.

The frequency band may be determined by at least one of a size and a spacing of unit patterns formed in the thermal insulation coating layer.

At least one of the size and the spacing of the unit patterns may be determined based on a wavelength of the frequency band.

At least one of an outer length and a spacing of the unit patterns may be shorter than the wavelength of the frequency band.

The unit patterns may include a first unit pattern configured to transmit radio waves of a first frequency band and a second unit pattern configured to transmit radio waves of a second frequency band.

The second unit pattern may be formed within the first unit pattern, and the second frequency band may be higher than the first frequency band.

The present disclosure provides a glass product including a plurality of glass layers, and at least one thermal insulation coating layer provided between the plurality of glass layers, and the at least one thermal insulation coating layer may be bonded to at least one of the plurality of glass layers, may include a pattern formed by removing a portion thereof, and may include at least one dielectric layer and at least one metal layer, and the at least one dielectric layer may have an entire area preserved.

The present disclosure provides a method of manufacturing a glass product including forming a thermal insulation coating layer on a glass, placing a laser processing apparatus on one side of the glass on which the thermal insulation coating layer is formed, and removing a portion of the thermal insulation coating layer using the laser processing apparatus, and the thermal insulation coating layer may include at least one dielectric layer and at least one metal layer, and at least one dielectric layer of the thermal insulation coating layer may be preserved over an entire area thereof.

### ADVANTAGEOUS EFFECTS

The disclosed technology may have the following effects. However, it should not be construed that the scope of the disclosed technology is limited thereto, as it does not mean that a specific embodiment must include all or only the following effects.

A glass product according to one embodiment of the present disclosure includes a glass layer and a thermal insulation coating layer, and the thermal insulation coating layer includes a pattern formed by removing a portion thereof. Therefore, the glass product according to one embodiment of the present disclosure may maintain characteristics of reflecting infrared light due to the thermal insulation coating layer, and may transmit radio waves in a frequency band used for wireless communication due to the pattern.

Further, in the glass product according to one embodiment of the present disclosure, at least one dielectric layer of the thermal insulation coating layer may be preserved over an entire area thereof. Therefore, in the glass product according to one embodiment of the present disclosure, visibility may be maintained because a pattern formed in the glass product is not easily recognized due to the dielectric layer, and durability may be maintained because corrosion of the metal layer is prevented.

### BRIEF DESCRIPTION OF THE DRAWINGS

FIGS. 1, 2A, and 2B are views illustrating a glass product according to one embodiment of the present disclosure.

FIGS. 3 and 4 are views illustrating a glass product according to another embodiment of the present disclosure.

FIGS. 5, 6A, and 6B are views illustrating a glass product according to still another embodiment of the present disclosure.

FIGS. 7 and 8 are exemplary views illustrating a pattern formed in a thermal insulation coating layer according to one embodiment of the present disclosure.

FIGS. 9A, 9B, and 9C are views illustrating a glass product having a multilayer structure according to one embodiment of the present disclosure.

FIG. 10 is a view illustrating a method of manufacturing a glass product according to one embodiment of the present disclosure.

### DETAILED DESCRIPTION

Since the present disclosure can be changed in various ways and have various embodiments, specific embodiments are illustrated in the drawings and described in detail in the detailed description.

However, the present disclosure is not limited to a specific embodiment, and all changes, equivalents, and replacements can be understood as being included in the spirit and scope of the present disclosure.

Although the terms “first”, “second”, etc. may be used herein to describe various components, these components should not be limited by these terms. These terms are only used to distinguish one component from another component. For instance, a first component could be termed a second component without departing from the scope of the present disclosure. Similarly, the second component could also be termed the first component. The term “and/or” includes any combination of a plurality of related listed items or any one of the plurality of related listed items.

It will be understood that when a component is referred to as being “coupled” or “connected” to another component, it can be directly coupled or connected to the other component or intervening components may be present therebetween. In contrast, it should be understood that when a component is referred to as being “directly coupled” or “directly connected” to another component, there are no intervening components present.

The terminology used herein is for the purpose of describing particular embodiments only and is not intended to be limiting. In the present disclosure, the singular forms are intended to include the plural forms as well, unless the context clearly indicates otherwise. It will be further understood that the terms “comprise” or “have”, etc., when used in this specification, specify the presence of stated features, integers, steps, operations, components, parts, and/or combinations thereof but do not preclude the presence or addition of one or more other features, integers, steps, operations, components, parts, and/or combinations thereof.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

Hereinafter, preferred embodiments of the present disclosure will be explained in detail with reference to the accompanying drawings. In describing the present disclosure, the same reference numerals are used to designate the same components throughout the drawings to facilitate overall understanding, and redundant descriptions of the same components are omitted.

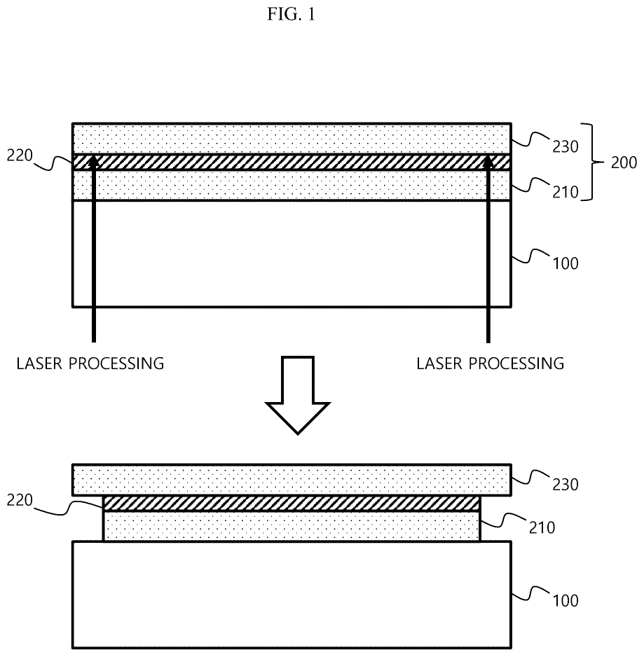

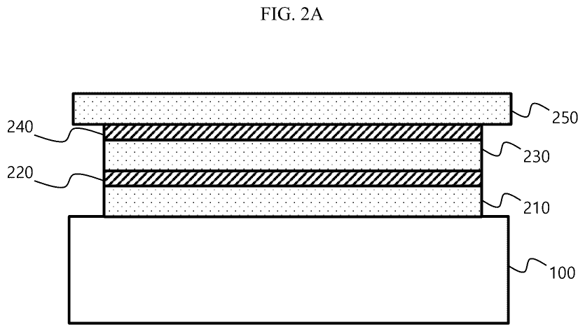

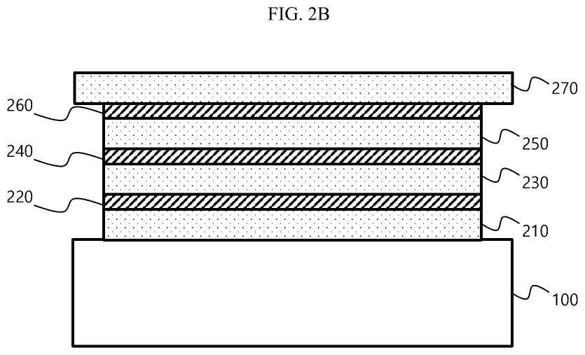

FIGS. 1, 2A, and 2B are views illustrating a glass product according to one embodiment of the present disclosure.

A glass product according to one embodiment of the present disclosure includes a glass layer 100 and a thermal insulation coating layer 200. The glass layer 100 may be used interchangeably with terms such as a base substrate and a glass substrate, and the thermal insulation coating layer 200 may be used interchangeably with terms such as a low-emissivity coating layer and a Low-E coating layer.

Referring first to FIG. 1, the thermal insulation coating layer 200 may be bonded onto the glass layer 100. Although not shown in FIG. 1, an adhesive layer may be provided between the glass layer 100 and the thermal insulation coating layer 200. The adhesive layer may include a binder for bonding the glass layer 100 and the thermal insulation coating layer 200.

The thermal insulation coating layer 200 may include at least one dielectric layer and at least one metal layer. Non-limitingly but more specifically, as illustrated in FIG. 1, the thermal insulation coating layer 200 may include a first dielectric layer 210 disposed on the glass layer 100, a metal layer 220 disposed on the first dielectric layer 210, and a second dielectric layer 230 disposed on the metal layer 220. Although not shown in FIG. 1, an intermediate protective layer may be provided between the first dielectric layer 210 and the metal layer 220 and/or between the metal layer 220 and the second dielectric layer 230 to improve adhesion between the dielectric layers 210 and 230 and the metal layer 220 and to protect the metal layer 220. Further, an upper protective layer may be provided on the second dielectric layer 230 to improve durability of the thermal insulation coating layer 200. The intermediate protective layer and the upper protective layer may include a metal such as nickel (Ni), chromium (Cr) or titanium (Ti), but the present disclosure is not limited thereto.

The first dielectric layer 210 and the second dielectric layer 230 may increase the durability of the thermal insulation coating layer 200 and may prevent oxidation of the metal layer 220 caused by oxygen and/or moisture in the atmosphere. For this purpose, as one example, the first dielectric layer 210 and the second dielectric layer 230 may include oxides and/or nitrides of silicon (Si), tin (Sn), zinc (Zn), or the like.

The metal layer 220 provides thermal insulation and may block solar heat and/or radiant heat. Non-limitingly but more specifically, the metal layer 220 may include silver (Ag) having characteristics of reflecting infrared light.

In the glass product according to one embodiment of the present disclosure, optical performance (such as visible light transmittance and color tone) and thermal insulation performance may vary depending on thicknesses of the dielectric layers 210 and 230 and/or the metal layer 220. For example, in the case of the dielectric layers 210 and 230, if the thickness is excessively large, the color of the glass product may be distorted or the coating may be delaminated; however, as the thickness increases, optical interference performance and protection performance of the metal layer 220 are improved. However, in the case of the metal layer 220, as the thickness increases, infrared reflectance is improved, whereas visible light transmittance is reduced. Thus, the metal layer 220 may have a thickness thinner than that of the dielectric layers 210 and 230. Non-limitingly but more specifically, the dielectric layers 210 and 230 may be implemented with the thickness of 20 nm to 80 nm, and the metal layer 220 may be implemented with the thickness of 5 nm to 18 nm.

Meanwhile, the thermal insulation coating layer 200 may include a pattern formed by removing a portion thereof. Non-limitingly but more specifically, after the thermal insulation coating layer 200 is formed on the glass layer 100, a portion of the thermal insulation coating layer 200 may be removed by laser processing, for example, ablation, scribing, or the like, so that a predetermined pattern may be formed on one surface of the thermal insulation coating layer 200. At this time, in the thermal insulation coating layer 200, the entire area of the second dielectric layer 230 may be preserved, as illustrated in FIG. 1. Thus, the thermal insulation coating layer 200 may include the first dielectric layer 210 in which the pattern is formed by laser processing and the second dielectric layer 230 in which the entire area thereof is preserved. To this end, laser processing may be performed from the glass layer 100 toward the second dielectric layer 230. At this time, portions of the first dielectric layer 210 and the metal layer 220 may be removed. Thus, in the case of the glass product according to one embodiment of the present disclosure, a portion of the metal layer 220 that causes radio wave loss is removed, so that infrared reflection performance may be maintained while radio waves in a frequency band used for wireless communication may be transmitted.

Meanwhile, unlike that illustrated in FIG. 1, if a portion of the second dielectric layer 230 is also removed by laser processing, optical performance of the glass product is degraded, so that the pattern formed on the thermal insulation coating layer 200 may be clearly identified even with the naked eye. Further, since the metal layer 220 is not protected from an external environment, the metal layer 220 may be corroded by oxygen and/or moisture in the atmosphere. When silver (Ag) is corroded, a silver sulfide film is formed on the glass layer 110, thereby causing discoloration of the glass product. However, in the glass product according to one embodiment of the present disclosure, since at least one dielectric layer 230 is preserved over an entire area thereof, even when the pattern is formed on the thermal insulation coating layer 200, the pattern is not easily recognized with the naked eye, thereby maintaining visibility, and corrosion of the metal layer 220 is prevented, thereby improving durability.

Meanwhile, the thermal insulation coating layer of the glass product according to one embodiment of the present disclosure may include a plurality of dielectric layers and a plurality of metal layers. Non-limitingly but more specifically, as illustrated in FIG. 2A, the thermal insulation coating layer may include a first dielectric layer 210, a first metal layer 220, a second dielectric layer 230, a second metal layer 240, and a third dielectric layer 250. Alternatively, as illustrated in FIG. 2B, the thermal insulation coating layer may include a first dielectric layer 210, a first metal layer 220, a second dielectric layer 230, a second metal layer 240, a third dielectric layer 250, a third metal layer 260, and a fourth dielectric layer 270. That is, in the case where the glass product according to one embodiment of the present disclosure includes the plurality of dielectric layers and the plurality of metal layers, the dielectric layers 210, 230, 250, and 270 and the metal layers 220, 240, and 260 may be alternately stacked on the glass layer 100. Although not illustrated in FIGS. 2A and 2B, in this case as well, an intermediate protective layer may be provided between each dielectric layer 210, 230, 250, 270 and each metal layer 220, 240, 260, and an upper protective layer may be provided on the uppermost portion of the glass product.

Referring to FIGS. 2A and 2B, even when the thermal insulation coating layer includes the plurality of dielectric layers and the plurality of metal layers, the thermal insulation coating layer may include a pattern formed by removing a portion thereof. Non-limitingly but more specifically, as illustrated in FIG. 2A, when the thermal insulation coating layer includes three dielectric layers 210 and 230, and 250 and two metal layers 220 and 240, laser processing may be performed from the glass layer 100 toward the thermal insulation coating layer so that portions of the metal layers 220 and 240 are removed to facilitate radio wave transmission, and in this process, portions of the first dielectric layer 210 and the second dielectric layer 230 may also be removed. In this case, the entire area (or the entire layer) of the third dielectric layer 250 may be preserved to maintain visibility of the glass product and to prevent corrosion of the thermal insulation coating layer. That is, the dielectric layer positioned on the uppermost portion of the thermal insulation coating layer may not be processed. As illustrated in FIG. 2B, even when the thermal insulation coating layer includes four dielectric layers 210, 230, 250, and 270 and three metal layers 220, 240, and 260, laser processing may be performed from the glass layer 100 toward the thermal insulation coating layer so that portions of the first dielectric layer 210, the first metal layer 220, the second dielectric layer 230, the second metal layer 240, the third dielectric layer 250, and the third metal layer 260 may be removed. Even in this case, the entire area of the fourth dielectric layer 270 positioned on the uppermost portion of the thermal insulation coating layer may be preserved to maintain visibility of the glass product and to prevent corrosion of the thermal insulation coating layer.

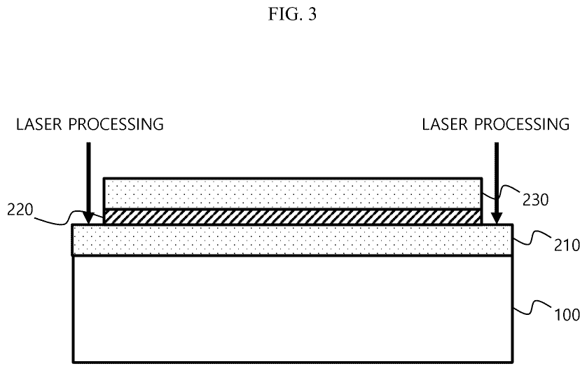

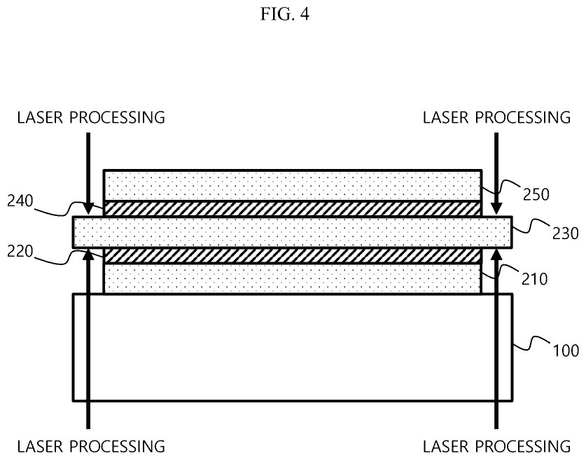

FIGS. 3 and 4 are views illustrating a glass product according to another embodiment of the present disclosure.

The glass product according to the present embodiment may include at least one dielectric layer and at least one metal layer, as in the embodiments of FIGS. 1, 2A, and 2B. However, the glass product according to the present embodiment may be formed through laser processing performed from the thermal insulation coating layer 200 toward the glass layer 100. In this case, as illustrated in FIG. 3, portions of the metal layer 220 and the second dielectric layer 230 of the thermal insulation coating layer 200 may be removed by the laser processing, while the entire area of the first dielectric layer 210 adjacent to the glass layer 100 may be preserved. That is, among the dielectric layers 210 and 230 of the thermal insulation coating layer 200, the dielectric layer 210 whose entire area is preserved may be disposed between the dielectric layer 230 in which a pattern is formed by the laser processing and the glass layer 100.

Meanwhile, when the thermal insulation coating layer includes a plurality of dielectric layers and a plurality of metal layers, a dielectric layer whose entire area is preserved may be provided between dielectric layers in which patterns are formed by laser processing, as illustrated in FIG. 4. In this case, the laser processing may be performed from the thermal insulation coating layer toward the glass layer and from the glass layer toward the thermal insulation coating layer. That is, in a thermal insulation coating layer having a structure in which two metal layers and three dielectric layers are stacked, portions of the upper dielectric layer and the upper metal layer may be removed by laser processing performed from the thermal insulation coating layer toward the glass layer, and portions of the lower dielectric layer and the lower metal layer may be removed by laser processing performed from the glass layer toward the thermal insulation coating layer, so that the entire area of the dielectric layer(s) provided between the lower metal layer and the upper metal layer may be preserved.

Thus, in the glass product according to the embodiments of FIGS. 3 and 4, since portions of the metal layer 220 are removed, radio-wave transmission performance may be improved, and since some of the dielectric layers included in the thermal insulation coating layer 200 are preserved over their entire areas, visibility may be maintained.

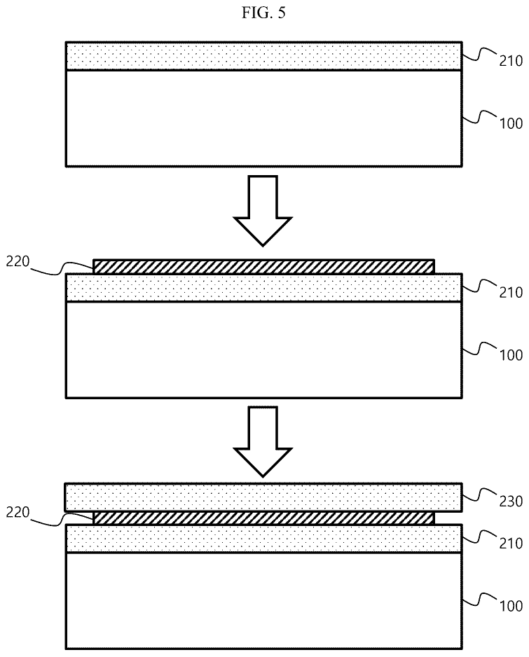

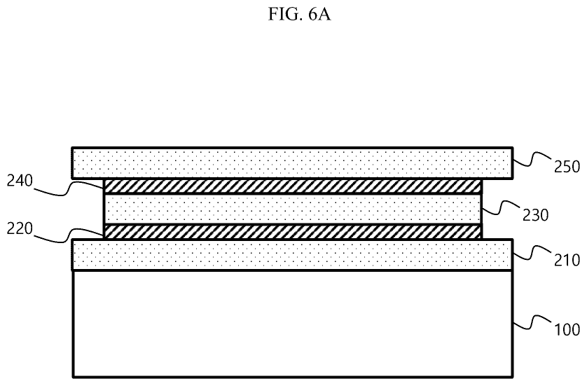

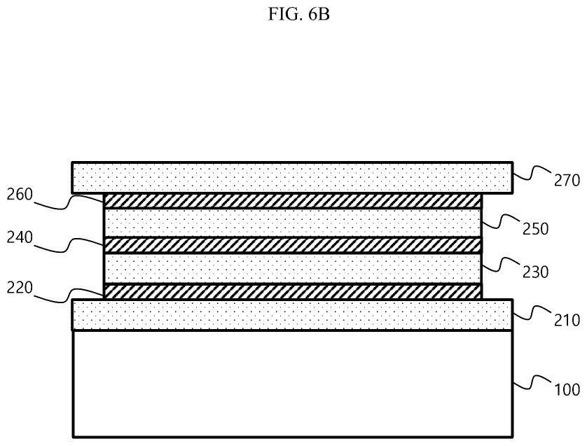

FIGS. 5, 6A, and 6B are views illustrating a glass product according to still another embodiment of the present disclosure.

The glass product according to the present embodiment may be manufactured, as shown in FIG. 5, by forming (coating and/or deposition) a first dielectric layer 210 on a glass layer 100, forming a metal layer 220 on the first dielectric layer 210, and then forming a second dielectric layer 230 on the metal layer 220, and repeating the above process at least once. In this case, a portion of the metal layer 220 may be removed, while an entire area of each of the dielectric layers 210 and 230 may be preserved. Thus, in the glass product according to the present embodiment, due to the metal layer 220 having a pattern formed in a portion thereof, radio-wave transmission performance may be improved while maintaining low-emissivity characteristics. In addition, even if a portion of the metal layer 220 is removed, all the dielectric layers 210 and 230 are preserved in the thermal insulation coating layer, thereby maintaining visibility and more effectively protecting the metal layer 220 from corrosion.

The above-described effects may be obtained, as shown in FIGS. 6A and 6B, even when the thermal insulation coating layer includes a plurality of dielectric layers 210, 230, 250, or 270 and metal layers 220, 240, or 260, as long as entire areas of a lowermost dielectric layer 210 and an uppermost dielectric layer 250 or 270 are preserved. That is, as shown in FIG. 6A, even when portions of the first metal layer 220, the second dielectric layer 230, and the second metal layer 240 are removed from the thermal insulation coating layer, the thickness of the removed portions is only on the order of several hundred nanometers. Likewise, as shown in FIG. 6B, even when portions of the first metal layer 220, the second dielectric layer 230, the second metal layer 240, the third dielectric layer 250, and the third metal layer 260 are removed from the thermal insulation coating layer, the thickness of the removed portions is only on the order of several hundred nanometers. Thus, when entire areas of the lowermost dielectric layer and the uppermost dielectric layer in the thermal insulation coating layer are preserved, radio-wave transmission performance may be improved while maintaining low-emissivity characteristics and visibility, and corrosion of the metal layers may be prevented.

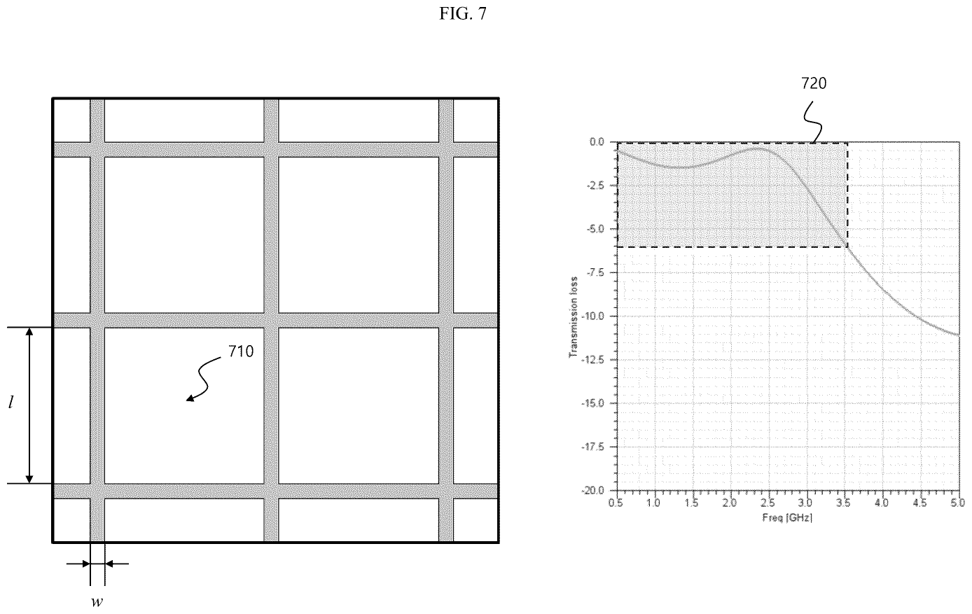

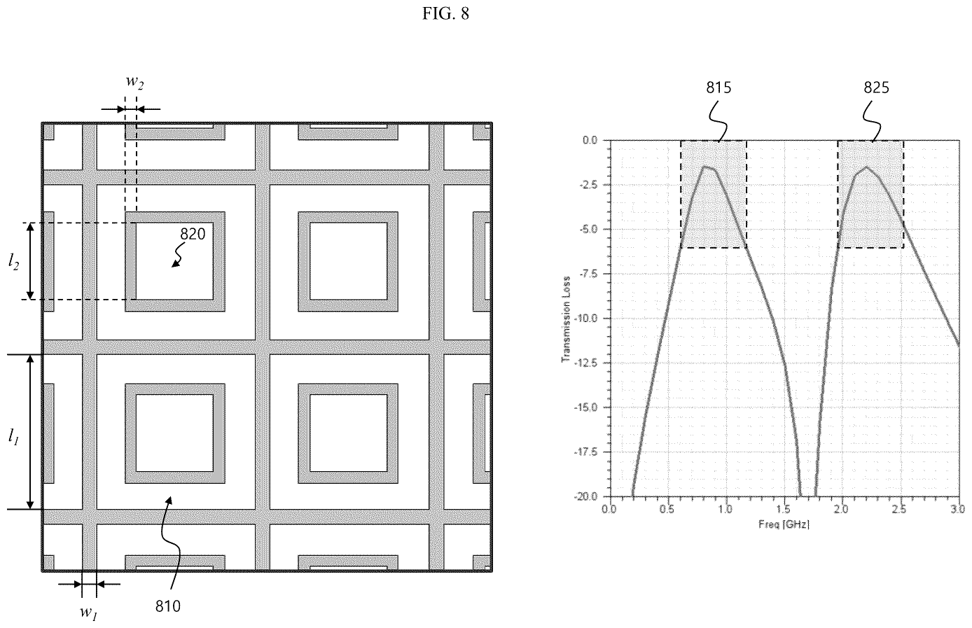

FIGS. 7 and 8 are exemplary views illustrating a pattern formed in a thermal insulation coating layer according to one embodiment of the present disclosure.

In the thermal insulation coating layer of the glass product according to one embodiment of the present disclosure, patterns having various shapes and/or sizes may be formed depending on a frequency band of radio waves to be transmitted. That is, a frequency band of radio waves transmitted by the glass product may be determined according to the shape, size, and/or spacing of the patterns formed in the thermal insulation coating layer.

Non-limitingly but more specifically, rectangular unit patterns as shown in FIG. 7 and/or FIG. 8 may be formed in the thermal insulation coating layer by removing portions thereof. Here, the size (or outer length) and/or spacing of each unit pattern may be determined based on the wavelength λ of a frequency band to be transmitted.

For example, referring to FIG. 7, an outer length l of a unit pattern 710 formed in the thermal insulation coating layer may be formed to be λ/3 or less, and a spacing between the unit patterns, that is, a width w of a removed portion, may be λ/20 or less. In this case, the glass product may allow radio waves of a frequency band 720 of, for example, 3.5 GHz or less to pass therethrough with low transmission loss. Therefore, in a building in which the glass product is installed, wireless communication may be smoothly performed even inside the building.

Meanwhile, as another example, as shown in FIG. 8, a first unit pattern 810 and a second unit pattern 820 may be formed in the thermal insulation coating layer. Here, the first unit pattern 810 may be configured to have a size and/or spacing for transmitting radio waves freq1 of a first frequency band 815, and the second unit pattern 820 may be configured to have a size and/or spacing for transmitting radio waves freq2 of a second frequency band 825.

Non-limitingly but more specifically, as shown in FIG. 8, the first frequency band 815 and the second frequency band 825 may respectively correspond to a band of 0.6 GHz to 1.2 GHz and a band of 2 GHz to 2.5 GHz. In this case, the second unit pattern 820 may be formed within the first unit pattern 810. A length l₁ and a spacing w₁ of the first unit pattern 810 may be configured to be λ_{freq1}/3 and λ_{freq1}/20 or less, respectively, and a length l₂ and a spacing w₂ of the second unit pattern 820 may be configured to be λ_{freq2}/3 and λ_{freq2}/20 or less, respectively.

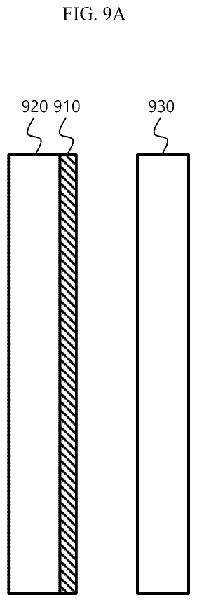

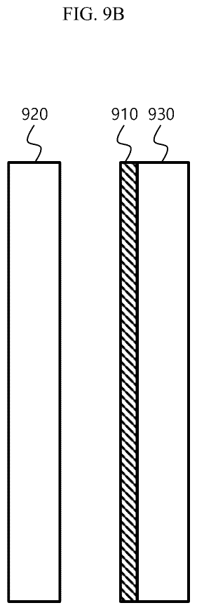

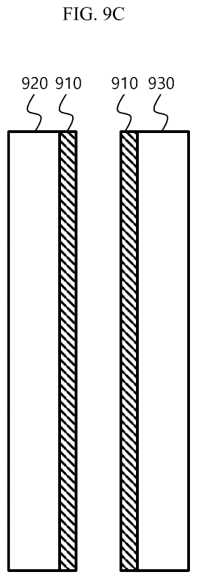

FIGS. 9A, 9B, and 9C are views illustrating a glass product having a multilayer structure according to one embodiment of the present disclosure.

Referring to FIGS. 9A to 9C, in the glass product having the multi-pane structure, a thermal insulation coating layer 910 may be provided on a first glass layer 920 side as shown in FIG. 9A, may be provided on a second glass layer 930 side as shown in FIG. 9B, or may be provided on both the first glass layer 920 and the second glass layer 930 as shown in FIG. 9C. Here, the thermal insulation coating layer 910 may have a stacked structure shown in at least one of FIGS. 1 to 6B. An air layer or a gas layer (e.g. argon gas) may be provided between the first glass layer 920 and the second glass layer 930.

In FIGS. 9A to 9C, when the first glass layer 920 corresponds to an outer glass and the second glass layer 930 corresponds to an inner glass, if the thermal insulation coating layer 910 is provided on the first glass layer 920 side as shown in FIG. 9A, a solar heat reflection effect may be enhanced in summer, and if the thermal insulation coating layer 910 is provided on the second glass layer 930 side as shown in FIG. 9B, a thermal insulation effect may be enhanced in winter. When the thermal insulation coating layer 910 is provided on both the first glass layer 920 and the second glass layer 930 as shown in FIG. 9C, manufacturing cost may increase, but both the solar heat reflection effect and the thermal insulation effect may be improved.

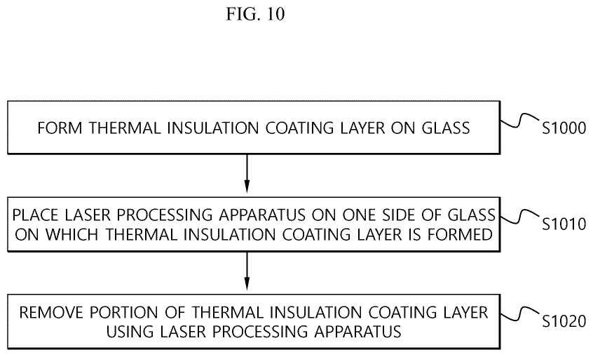

FIG. 10 is a view illustrating a method of manufacturing a glass product according to one embodiment of the present disclosure.

Referring to FIG. 10, the glass product according to one embodiment of the present disclosure may be manufactured through a process S1000 of forming a thermal insulation coating layer on glass, a process S1010 of placing a laser processing apparatus on one side of the glass on which the thermal insulation coating layer is formed, and a process S1020 of removing a portion of the thermal insulation coating layer using the laser processing apparatus. Here, the thermal insulation coating layer may include at least one dielectric layer and at least one metal layer.

When the thermal insulation coating layer is formed on the glass, the laser processing apparatus may be placed on a front surface of the glass, and a processing area may be set based on information on radio waves to be transmitted. Here, the processing area may be set based on a wavelength of a frequency band including a frequency of the radio waves. Non-limitingly but more specifically, the laser processing apparatus may remove a portion of the thermal insulation coating layer with a size of one third or less of the wavelength of the radio waves to be passed and with a width of one twentieth or less of the wavelength. At this time, at least one of dielectric layers included in the thermal insulation coating layer may not be removed by the laser processing and an entire area thereof may be preserved. The glass product manufactured through such a process may maintain low emissivity characteristics and visibility while improving radio wave transmission performance, enabling smooth wireless communication, and preventing corrosion of the metal layer, thereby enhancing durability.

Although the present disclosure has been described above with reference to the drawings and embodiments, it should be understood that the protection scope of the present disclosure is not limited by the drawings or the embodiments. Rather, those skilled in the art will appreciate that various modifications and changes may be made without departing from the spirit and scope of the present disclosure as set forth in the appended claims.

Although the present disclosure has been described based on a series of functional blocks, it is not limited to the above-described embodiments and the accompanying drawings, and it will be apparent to those skilled in the art that various substitutions, modifications, and alterations may be made without departing from the technical spirit of the present disclosure.

Combinations of the foregoing embodiments are not limited to the specific embodiments described above, and various combinations may be provided depending on implementation and/or requirements, in addition to the foregoing embodiments.

In the foregoing embodiments, the methods have been described based on flowcharts as a series of steps or blocks. However, the present disclosure is not limited to the order of the steps, and some steps may occur in a different order from that described above or may occur simultaneously. In addition, those skilled in the art will understand that the steps shown in the flowcharts are not exclusive, that other steps may be included, and that one or more of the steps shown in the flowchart may be omitted without affecting the scope of the present disclosure.

The foregoing embodiments include examples of various aspects. Although it is not possible to describe all possible combinations for illustrating the various aspects, those skilled in the art will recognize that other combinations are possible. Thus, the present disclosure is intended to embrace all such alterations, modifications, and variations that fall within the following claims.

What is claimed is:

1. A glass product comprising:
a glass layer; and
a thermal insulation coating layer bonded to the glass layer and including a pattern formed by removing a portion thereof,
wherein the thermal insulation coating layer comprises at least one dielectric layer and at least one metal layer, and
wherein at least one dielectric layer of the thermal insulation coating layer is preserved over an entire area thereof.

2. The glass product of claim 1, wherein the thermal insulation coating layer comprises a dielectric layer in which the pattern is formed, and a dielectric layer having an entire area preserved.

3. The glass product of claim 2, wherein the dielectric layer having the entire area preserved maintains visibility of the glass product.

4. The glass product of claim 2, wherein:
the at least one metal layer comprises silver, and
the dielectric layer having the entire area preserved prevents corrosion of the silver.

5. The glass product of claim 2, wherein:
the dielectric layer in which the pattern is formed is provided between the dielectric layer having the entire area preserved and the glass layer, and
the pattern is formed by laser processing performed from the glass layer toward the at least one metal layer.

6. The glass product of claim 2, wherein:
the dielectric layer having the entire area preserved is provided between the dielectric layer in which the pattern is formed and the glass layer, and
the pattern is formed by laser processing performed from the at least one metal layer toward the glass layer.

7. The glass product of claim 1, wherein a thickness of the at least one metal layer is thinner than a thickness of the at least one dielectric layer.

8. The glass product of claim 1, wherein the pattern determines a frequency band of radio waves transmitted through the glass product.

9. The glass product of claim 8, wherein the frequency band is determined by at least one of a size and a spacing of unit patterns formed in the thermal insulation coating layer.

10. The glass product of claim 9, wherein at least one of the size and the spacing of the unit patterns is determined based on a wavelength of the frequency band.

11. The glass product of claim 10, wherein at least one of an outer length and a spacing of the unit patterns is shorter than the wavelength of the frequency band.

12. The glass product of claim 9, wherein the unit patterns comprise a first unit pattern configured to transmit radio waves of a first frequency band and a second unit pattern configured to transmit radio waves of a second frequency band.

13. The glass product of claim 12, wherein:
the second unit pattern is formed within the first unit pattern, and
the second frequency band is higher than the first frequency band.

14. A glass product comprising:
a plurality of glass layers; and
at least one thermal insulation coating layer provided between the plurality of glass layers,
wherein the at least one thermal insulation coating layer is bonded to at least one of the plurality of glass layers, comprises a pattern formed by removing a portion thereof, and comprises at least one dielectric layer and at least one metal layer, and
wherein the at least one dielectric layer has an entire area preserved.

15. A method of manufacturing a glass product comprising:
forming a thermal insulation coating layer on a glass;
placing a laser processing apparatus on one side of the glass on which the thermal insulation coating layer is formed; and
removing a portion of the thermal insulation coating layer using the laser processing apparatus,
wherein the thermal insulation coating layer comprises at least one dielectric layer and at least one metal layer, and
wherein at least one dielectric layer of the thermal insulation coating layer is preserved over an entire area thereof.
